(19) United States
(12) Patent Application Publication
(10) Pub. No.: US 2018/0372133 A1
(43) Pub. Date: Dec. 27, 2018

(54) WORK DEVICE HAVING A HYDRAULIC DRIVE FOR CIVIL ENGINEERING WORK

(71) Applicant: ABI Anlagentechnik-Baumaschinen-lndustriebedarf Maschinenfabrik und Vertriebsgesellschaft mbH, Niedernberg (DE)

(72) Inventors: Christian HEICHEL, Niedernberg (DE); Albrecht KLEIBL, Grossostheim (DE)

(73) Assignee: ABI Anlagentechnik-Baumaschinen-lndustriebedarf Maschinenfabrik und Vertriebsgesellschaft mbH, Niedernberg (DE)

(21) Appl. No.: 15/963,170

(22) Filed: Apr. 26, 2018

(30) Foreign Application Priority Data
Jun. 22, 2017 (EP) 17177475.5

(51) Int. Cl. F15B 21/04; F01P 3/20; F01P 7/16; F15B 1/26; F01N 3/02; F02B 29/04; F15B 21/06

(52) U.S. Cl. CPC F15B 21/042; F01P 3/20; F01P 7/16; E02D 7/18; F01N 3/0205; F02B 29/0437; F15B 21/06; F15B 1/26

(57) ABSTRACT

A work device having a hydraulic drive for civil engineering work, in particular a drilling device or vibration pile-driving device, includes a hydraulic motor that is operated by way of a fluid of a hydraulic circuit, which circuit is supplied by way of a hydraulic pump, which pump is driven by an internal combustion engine, wherein at least one heat transfer unit for transfer of thermal energy of a fluid stream of the internal combustion engine to the fluid of the hydraulic circuit is provided. A method temporarily heats the hydraulic fluid of the hydraulic circuit of such a work device.

### CROSS REFERENCE TO RELATED APPLICATIONS

Applicant claims priority under 35 U.S.C. § 119 of European Application No. 17177475.5 filed Jun. 22, 2017, the disclosure of which is incorporated by reference.

### BACKGROUND OF THE INVENTION

### 1. Field of the Invention

The invention relates to a work device having a hydraulic drive for civil engineering work, in particular a drilling device or vibration pile-driving device. The invention furthermore relates to a method for temporary heating of the hydraulic fluid of the hydraulic circuit of a work device having a hydraulic drive for civil engineering work, in particular of a drilling device or vibration pile-driving device.

### 2. Description of the Related Art

In construction, different work devices having a hydraulic drive for civil engineering work are operated in a hydraulic group. The hydraulic group usually consists of a hydraulic pump, which is driven by an internal combustion engine, a work device having a hydraulic drive, in particular a hydraulic motor, as well as a control or regulation unit. The hydraulic group is operated with a fluid in a hydraulic circuit. The product of the pressure stream and volume stream of the fluid results in the hydraulic power.

Vibration pile-drivers or vibrators are used as work devices, for example, in order to introduce objects such as steel profiles, for example, into the ground or to pull them from the ground. Such vibration pile-drivers or vibrators are also used to compact ground material. The ground is excited by means of vibration and thereby achieves a “pseudo-fluid” state. The material to be pile-driven can then be pressed into the ground by means of a static top load. Vibration pile-drivers normally have vibration exciters that act in linear manner, the centripetal force of which exciters is generated by means of rotating imbalances. The progression of the speed of the linear vibration exciter corresponds to a periodically recurring function, for example a sine function. The vibration exciters are operated with hydraulic rotary drives, which put the shafts on which the imbalances are disposed into rotation.

Further work devices having a hydraulic drive that are widespread in construction are what are called drilling devices. These devices are used, among other things, for the production of pile foundations, for example drilled piles or concrete piles for increasing the carrying capacity of the foundation soil, or for soil replacement measures. The drilling drives connected with the drilling device are normally hydraulic rotary drives on which drill pipes or drilling tools are attached.

Several hundreds of liters of hydraulic oil circulate in the hydraulic circuits of such hydraulically driven drilling devices or vibration pile-driving devices. Because of the degrees of effectiveness of hydraulic machines and of a hydraulic power transfer, the oil must absorb large amounts of waste heat. This energy heats the oil up, so that it achieves a temperature of advantageous viscosity. At the same time, the heat is emitted to the surroundings by way of the components of the hydraulic group, and extracted by an additionally provided cooler at a given temperature. The goal is to adjust the oil temperature and, in particular, the oil viscosity so that the wear of the hydraulic machines, such as pumps and motors, and their power losses are as low as possible. Usually, a loaded diesel engine serves to drive the hydraulic pumps.

At low ambient temperatures, short turn-on times or in the case of machines that adapt the circulating oil volume stream to the power being called for from the work device, as described in EP 2 557 233 B1, conditions can occur, for certain periods of time, in which the advantageous operating state with regard to oil temperature and viscosity is not reached. At an increasing viscosity of the hydraulic oil, the power available at the work device is reduced. Because of the high power loss, the fuel consumption of the internal combustion engine is simultaneously increased. Furthermore, the hydraulic oil no longer corresponds to the specifications prescribed by the manufacturer of the components of the hydraulic pumps and hydraulic motors, and therefore increased wear must be expected.

In order to avoid the aforementioned disadvantages, it is known to preheat the hydraulic oil using electrical or also diesel-operated auxiliary heating systems. In order to heat an oil volume of several hundreds of liters by 30° C. to 50° C., the energy required lies in the two-digit kilowatt-hour range. In practice, the required energy can be even clearly greater, because hydraulic systems are generally not insulated, but rather structured in such a manner that they give off as much heat as possible to the surroundings. Furthermore, it is known to dispose heating rods in the hydraulic oil tank for oil preheating. Aside from the high amount of energy required here, too, it has proven to be a disadvantage of this solution that hydraulic oil that is situated directly on the mantle surface of a heating rod is heated very much at certain points, and therefore it can be damaged.

### SUMMARY OF THE INVENTION

The invention wishes to provide a remedy for this situation. The invention is based on the task of making available a work device having a hydraulic drive for civil engineering work, in particular a drilling device or vibration pile-driving device, in which temporary heating of the hydraulic fluid is made possible without additionally supplying outside energy.

These and other tasks are accomplished with a work piece according to one aspect of the invention. With the invention, a work device having a hydraulic drive for civil engineering work, in particular a drilling device or vibration pile-driving device, is made available, in which temporary heating of the hydraulic fluid is made possible without supplying additional outside energy. Because at least one heat transfer unit for transferring thermal energy of a fluid stream of the internal combustion engine to the fluid of the hydraulic circuit is provided, temporary heating of the hydraulic fluid by the waste heat or heat loss of the internal combustion is brought about. The auxiliary heating system that is additionally present in the state of the art and is supplied with outside energy is no longer required. The overall degree of effectiveness of the work device is thereby increased.

In the present instance, the term “heat transfer unit” should be understood to mean any device that is suitable for transferring thermal energy of a fluid stream of the internal combustion engine to the fluid of the hydraulic circuit.

In a further development of the invention, the hydraulic circuit and the cooling circuit of the internal combustion engine are thermally connected by way of a heat transfer unit. In this way, the waste heat of the cooling circuit of the internal combustion engine is used for heating the hydraulic fluid, and thereby, at the same time, the required cooling power of the internal combustion engine is reduced. Because of the reduced cooling power of the cooler of the internal combustion engine that is required, a reduction in fuel consumption is achieved, in turn, and thereby the energy efficiency of the work device is further increased, in turn.

In a further embodiment of the invention, the heat transfer unit is set up for combined transfer of heat and material, wherein the hydraulic fluid is identical with the coolant, and wherein the heat transfer unit comprises means for coupling and uncoupling the hydraulic circuit and the cooling circuit, which means preferably comprise a bypass line connected by way of a multi-way valve. As a result, the hydraulic fluid of the hydraulic circuit can be passed directly through the cooling circuit of the internal combustion engine, thereby achieving maximal heat transfer to the hydraulic fluid. After the desired heating of the hydraulic fluid is achieved, the hydraulic circuit can once again be uncoupled from the cooling circuit. Possible overheating of the hydraulic fluid is thereby prevented. Preferably, a synthetic ester or hydraulic environmental ester oil synthetic (HEES) is used as the hydraulic fluid and as the coolant.

It is advantageous if connection of the hydraulic circuit and of the cooling circuit takes place by way of a hydraulic fluid tank disposed in the hydraulic circuit. In this way, uniform heating of a large hydraulic fluid volume is made possible.

In an alternative embodiment of the invention, the heat transfer unit comprises a heat exchanger that is disposed ahead of the cooler in the cooling circuit of the internal combustion engine, wherein it is advantageous if the cooling circuit and/or the hydraulic circuit has a bypass line that circumvents the heat transfer unit, in which line a valve is disposed, which valve can be controlled as a function of the temperature of the hydraulic fluid stream and/or of the coolant stream. In this regard, a heat exchanger can be used, in particular, in which the coolant is passed along the hydraulic fluid using a same-current or counter-current method, thereby achieving heat transfer to the hydraulic fluid. Depending on the temperature of the hydraulic fluid stream or also of the coolant stream, the heat exchanger can be uncoupled from the cooling circuit by means of the bypass line. Overheating of the hydraulic fluid or also of the coolant of the cooling circuit of the internal combustion engine is thereby counteracted.

In a further development of the invention, the heat transfer unit is connected with the hydraulic circuit by way of a valve, which can be controlled by way of a control and regulation module, wherein a temperature sensor is disposed in the hydraulic circuit, which sensor is connected with the control and regulation module. In this way, automatic regulation of the temperature of the hydraulic fluid is made possible. In this regard, the regulation module is configured so that the actual temperature yielded by the temperature sensor is compared with a reference temperature stored in memory. If a difference exists between the actual temperature and the reference temperature, taking into consideration a tolerable temperature difference that is also stored in memory, control of the valve by the control and regulation module takes place, thereby opening or closing the bypass line. In this way, temporary heating of the hydraulic fluid, based on need, is made possible. When the maximally permissible viscosity of the hydraulic fluid is achieved, uncoupling of the hydraulic circuit from the heat transfer unit is thereby made possible.

In an embodiment of the invention, the hydraulic circuit and the exhaust gas stream of the internal combustion engine are thermally connected by way of a heat transfer unit, in particular a heat exchanger. In this way, utilization of the waste heat of the exhaust gas stream of the internal combustion engine for heating the hydraulic fluid is brought about, thereby further increasing the energy efficiency of the work device.

In a further embodiment of the invention, an outlet line is disposed on the internal combustion engine, which line is provided with a branch that is connected with the heat transfer unit. It is advantageous if the outlet line is provided with a throttle system, by way of which it can be temporarily closed. In this way, temporary feed of the exhaust gas stream to the heat transfer unit is achieved, thereby counteracting overheating of the hydraulic fluid.

In a further embodiment of the invention, the exhaust gas stream is thermally connected with the hydraulic circuit by way of a transfer circuit having a heat carrier fluid, which circuit is operated by way of a pump. In this regard, a control and regulation module is preferably provided, by way of which the pump of this transfer circuit can be controlled, wherein a temperature sensor is disposed in the hydraulic circuit, which sensor is connected with the control and regulation module. In this way, a transfer circuit that can be controlled as a function of the temperature of the hydraulic fluid is achieved, and thereby feed of heat energy obtained from the exhaust gas to the hydraulic fluid is made possible. Preferably, the heat carrier fluid is an ester, a salt melt or a liquid metal. It is advantageous if the transfer circuit has two heat exchangers, by way of which it is thermally connected with the exhaust gas stream on the one side and with the hydraulic circuit on the other side.

In a further embodiment of the invention, the internal combustion engine has a charger, and the compressed charging air stream of the charger and the hydraulic circuit are thermally connected by way of a heat transfer unit, which preferably comprises a heat exchanger. The heat transfer unit is preferably disposed in the charging air line behind the charger. In this way, utilization of the waste heat of the compressed charging air stream for heating the hydraulic fluid is made possible. A heat transfer circuit can also be provided as a heat transfer unit, which circuit is connected with the charging air stream as well as the hydraulic circuit by way of a heat exchanger, in each instance, and operated by way of a pump, which can preferably be controlled by way of a control and regulation module that is provided and connected with a temperature sensor disposed in the hydraulic circuit.

The present invention is furthermore based on the task of making available a method for temporary heating of the hydraulic fluid of the hydraulic circuit of a work device having a hydraulic drive for civil engineering work, in particular a drilling device or vibration pile-driving device, which method allows guaranteeing a required viscosity range of the hydraulic fluid without supplying additional outside energy.

These and other tasks are accomplished by means of a method according to another aspect of the invention. With the invention, a method for temporary heating of the hydraulic fluid of the hydraulic circuit of a work device having a hydraulic drive for civil engineering work, in particular a drilling device or vibration pile-driving device, is made available, which method allows guaranteeing a required viscosity range of the hydraulic fluid without supplying additional outside energy. Because the hydraulic fluid is passed through a heat transfer unit for a defined period of time, to which unit a fluid stream of the internal combustion engine is supplied for transfer of thermal energy, heating of the hydraulic fluid is brought about exclusively by way of waste heat or heat loss of the internal combustion engine. In this way, the energy efficiency of the work device is increased.

In a further development of the invention, the heat transfer unit is connected with the hydraulic circuit by way of a bypass line, in which a multi-way valve is disposed. In this way, the heat transfer unit can be coupled and uncoupled as needed, thereby counteracting overheating of the hydraulic fluid. Here, in particular, a heat exchanger according to the same-current or counter-current principle can be used as a heat transfer unit.

In a further development of the invention, the cooling circuit of the internal combustion engine is used as a combined material and heat transfer unit, wherein the hydraulic fluid is simultaneously used as a coolant, and wherein the hydraulic circuit is connected with the cooling circuit of the internal combustion engine for a defined period of time, as needed. In this way, direct, highly efficient heat transfer of the heat loss of the internal combustion engine to the hydraulic fluid is brought about, in particular without involvement of an additional heat exchanger. As a result, heating of the hydraulic fluid is made possible in a short time. At the same time, a cooling effect on the internal combustion engine is brought about by the hydraulic fluid, and for this reason, the cooling power to be provided in addition to that via the cooler is reduced, and this in turn results in a reduction in the fuel consumption of the internal combustion engine.

Preferably, a synthetic ester is used both as the hydraulic fluid and as the coolant. Esters are characterized, as compared with mineral oils, not only by their very good biodegradability but also by a higher viscosity index, and for this reason they are very suitable as a hydraulic fluid. Furthermore, they are not sensitive to extreme work temperatures, whereas mineral oils age very quickly at high temperatures. Furthermore, esters can be used permanently at a temperature of 120° C., and for this reason they are also suitable as a coolant for the internal combustion engine. In this regard, the further advantage occurs that the cooling circuit only needs to be structured to be pressure-resistant at clearly higher temperatures, in contrast to the use of conventional engine coolant.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a schematic representation of the hydraulic group of a work device with coupling of the hydraulic circuit to the cooling circuit of the internal combustion engine by way of a heat exchanger;

FIG. 2 shows a representation of the hydraulic group of a work device with coupling of the hydraulic circuit to the cooling circuit of the internal combustion engine by way of a heat exchanger in a further embodiment;

FIG. 3 shows a representation of the hydraulic group of a work device with connection of the hydraulic circuit with the cooling circuit of the internal combustion engine;

FIG. 4 shows a representation of the hydraulic group of a work device with connection of the hydraulic circuit with the cooling circuit of the internal combustion engine in a further embodiment;

FIG. 5 shows a schematic representation of a hydraulic group of a work device with coupling of the hydraulic circuit to the exhaust gas stream of the internal combustion engine by way of a heat exchanger circuit; and

FIG. 6 shows a representation of the hydraulic group of a work device with coupling of the hydraulic circuit not only to the cooling circuit of the internal combustion engine by way of a heat exchanger but also to the exhaust gas stream of the internal combustion engine by way of a heat exchanger circuit.

### DETAILED DESCRIPTION OF PREFERRED EMBODIMENTS

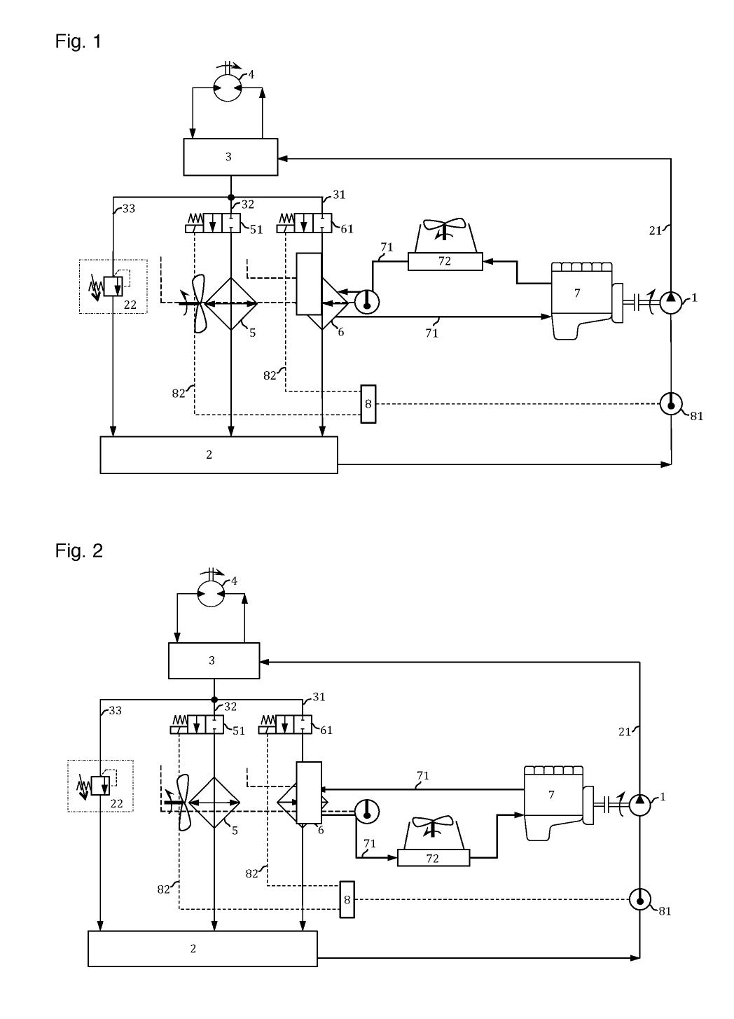

In FIG. 1, the hydraulic group of a work device having a hydraulic drive for civil engineering work, for example of a drilling device or vibration pile-driving device, is shown schematically. It comprises a hydraulic pump 1, which is disposed in the line 21 between a hydraulic oil tank 2 and a control block 3 and driven by an internal combustion engine 7. The control block 3 is connected with a hydraulic motor 4, the hydraulic oil inflow of which it controls. The control block 3 is connected with the hydraulic oil tank 2 by way of three lines 31, 32, 33 on the return side. The first line 31 is passed by way of a heat exchanger 6 as a coupling line, by way of a 2/2-way valve 61. The second line 32 is passed by way of a cooler 5 by way of a further 2/2-way valve 51. In the third line 33, a sequence valve 22 is provided as a failure valve, which valve can also be used as a free line to the tank in order to minimize pressure losses.

Usually, pressure-limiting valves, which can also be integrated into the valves in the form of a pressure stage, are provided in addition to the 2/2-way valves 51, 61 as well as the failure valve 22. In this regard, these pressure-limiting valves are biased in such a manner that significant ram pressures of 5.5 bar and more are guaranteed. In this way, a significant energy demand on the order of up to 12 kW is caused. These ram pressures are kept available in order to prevent cavitation when the work device, which can be a vibrator with rotating imbalance masses, for example, is stopped. It was found that this significant energy demand can be significantly reduced in that the aforementioned valves are structured as controllable proportional valves. Because the significant ram pressures are required only in certain states, the proportional valves can be set at significantly lower ram pressures in normal operation. Depending on events, for example when the work device is shut off, the proportional valves can then be adjusted by way of a controller connected with them, in such a manner that a high ram pressure is formed—if necessary even higher than the aforementioned 5.5 bar.

The line 31, on the one hand, and the cooling circuit 71 of the internal combustion engine 7, on the other hand, are passed by way of the heat exchanger 6. In this regard, the heat exchanger 6 is connected behind the cooler 72 in the cooling circuit. The temperature in the line from the cooler 72, which cools the coolant of the internal combustion engine 7, to the internal combustion engine 7 amounts to less than 90° C. in most engines. The hydraulic oil can be exposed to this temperature for a longer time. If hydraulic oil remains in the heat exchanger 6, which reaches this temperature, the hydraulic oil is not damaged. The waste heat of the internal combustion engine 7, which is absorbed by the coolant, however, will not be utilized maximally in this case, because a large part of the heat energy has already been given off to the surroundings in the prior cooler 72.

A better degree of effectiveness is achieved if the heat exchanger 6 is connected with the line from the internal combustion engine 7 to the cooler 72 (as shown in FIG. 2). In this regard, however, it should be noted that the coolant temperature is possibly too high here to allow standing hydraulic oil, which is not constantly exchanged, to remain in the heat exchanger 6.

In this case, the heat exchanger 6 preferably should be separated from the supply of the engine coolant during the time when the first line 31 is closed by way of the 2/2-way valve 61, in other words when the hydraulic oil is not passed by way of the first line 31, in order to interrupt the supply of heat. For this purpose, a bypass line that circumvents the heat exchanger 6 and can be coupled in by way of a provided valve, for example, could be provided in the cooling circuit 71 of the internal combustion engine 7.

In the exemplary embodiment, a temperature sensor 81 is disposed in the line 21 between the pump 1 and the hydraulic tank 2, which sensor is connected with a control and regulation device 8. The control and regulation device 8 is connected with the 2/2-way valves 51, 61 by way of control lines 82, and set up in such a manner that in the event that the temperature reported by the temperature sensor 81 is lower than a limit temperature stored in the memory of the control and regulation device 8, the 2/2-way valve 61 is opened and the 2/2-way valve 51 is closed. In this position, the hydraulic oil is passed by way of the heat exchanger 6 by the control block 3, and thereby it is heated. After a target temperature stored in the memory of the control and regulation device 8, the 2/2-way valve 61 is closed and the 2/2-way valve 51 is opened, and afterward, the hydraulic oil is passed to the hydraulic oil tank 2 by way of the cooler 5 by the control block 3.

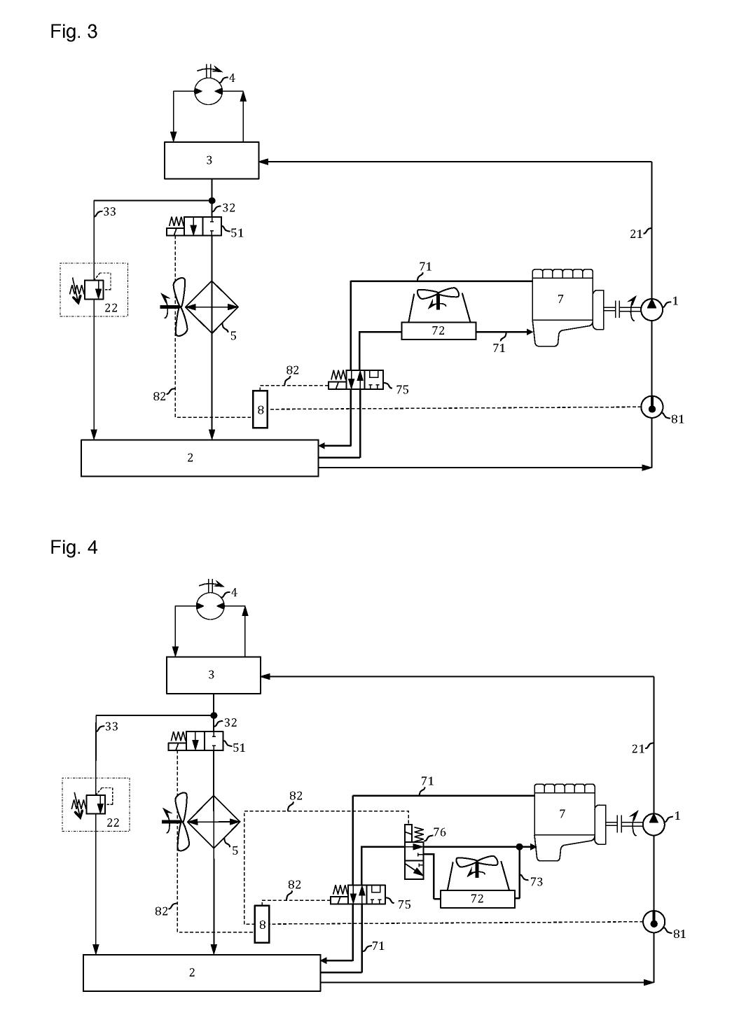

In the exemplary embodiment according to FIG. 3, the heat transfer unit is set up for combined material and heat transfer. An essential component of the heat transfer unit is the hydraulic oil tank 2 that is present here. In this regard, an identical fluid is used for the hydraulic circuit of the hydraulic motor 4 and as a coolant for the cooling circuit 71 of the internal combustion engine 7. The hydraulic oil tank 2 of the hydraulic circuit is directly connected with the cooling circuit 71 of the internal combustion engine 7 here, by way of an interposed 4/2-way valve 75. The 4/2-way valve 75, just like the 2/2-way valve 51, is connected with the control and regulation device 8 by way of control lines 82, and can be controlled by this device.

If the 4/2-way valve 75 is set by the control and regulation device 8 in such a manner that the incoming and return lines of the cooling circuit 71 are set to be open, the hydraulic oil is conveyed directly out of the hydraulic oil tank 2 into the cooling circuit 71 of the internal combustion engine 7 by way of the coolant pump—not shown—of the internal combustion engine 7, and thereby it is heated directly, without the involvement of a heat exchanger, by the waste heat of the internal combustion engine 7, before it is passed back into the hydraulic oil tank 2.

In the exemplary embodiment according to FIG. 4, the cooler 72 is disposed in a bypass line 73, which is connected with the cooling circuit 71 by way of a 3/2-way valve 76 on the supply side. In this way, the cooler 72 can be uncoupled during times in which it is not required. In the exemplary embodiment, the 3/2-way valve 76 is also connected with the control and regulation device 8 by way of control lines 82, and can be controlled by this device.

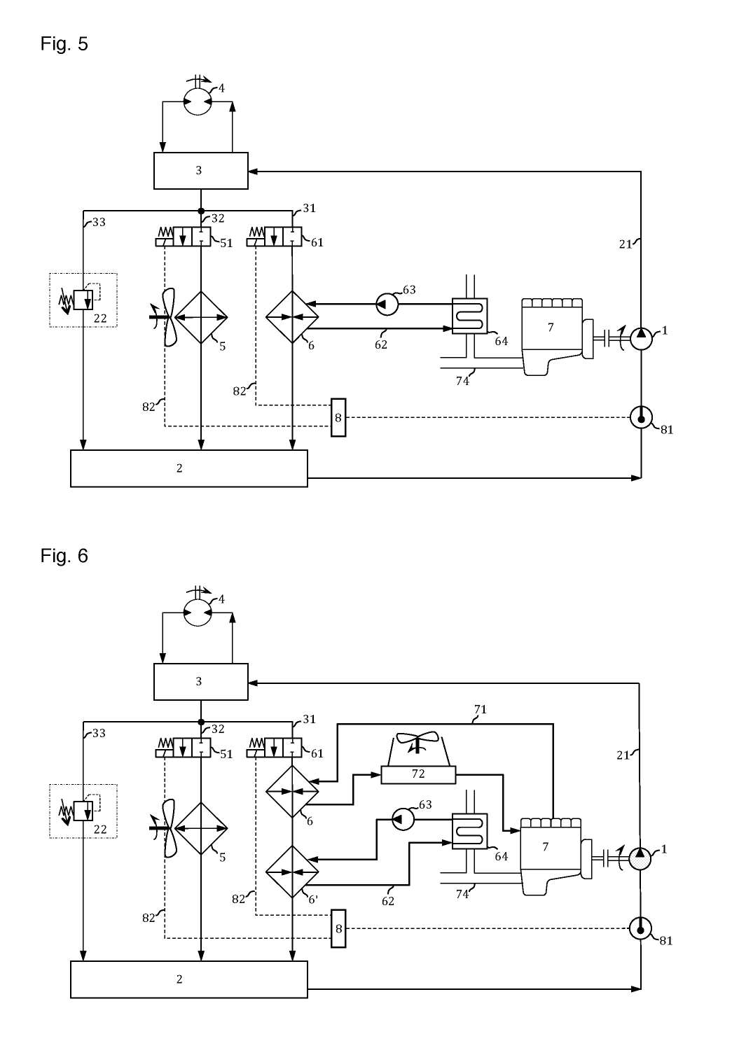

In the exemplary embodiment according to FIG. 5, the heat exchanger 6 is incorporated into a heat transfer circuit 62. The heat transfer circuit 62 comprises a pump 63, by way of which a heat transfer medium is circulated between this heat exchanger 6 and a second heat exchanger 64 that is provided. The second heat exchanger 64 is connected with the exhaust gas line 74 of the internal combustion engine 7, so that the exhaust gas stream of the internal combustion engine 7 can flow through it.

Because very high temperatures can prevail in the region of the exhaust gas line 74, an ester, as a temperature-resistant medium, is interposed as a heat transfer medium. Salt melts or, theoretically, also liquid metals can also be used as further temperature-resistant heat carrier fluids. The second heat exchanger 64, directly disposed at the exhaust gas line 74 of the internal combustion engine 7, transfers the heat to the intermediate medium, by way of which the heat is in turn transferred to the hydraulic oil by way of the first heat exchanger 6. To interrupt the heat supply to the hydraulic oil, the pump 63 can simply be shut off. For this purpose, it is practical to also connect the pump 63 with the control and regulation device 8, which in this case must be set up in such a manner that if the 2/2-way valve 61 is interrupted, the pump 63 is simultaneously shut off or that in the pass-through position of the 2/2-way valve 61, the pump 63 is activated.

Alternatively, the second heat exchanger 64 can also be disposed on a charger of an internal combustion engine 7, preceding the charging air cooler, in order to utilize the heat of the charging air stream, which also has a very high temperature, for heating the hydraulic oil. Of course, it is also possible to provide multiple heat exchangers, in order to utilize the different waste heat sources of the internal combustion engine for heating the hydraulic oil. For example, a third heat exchanger, by way of which the charging air stream is conducted, can also be provided in the heat transfer circuit 62.

The possibility also exists of branching off the exhaust gas system, for example after a catalytic converter that is present, in order to utilize the exhaust gas heat, and conducting one train to the exhaust pipe unchanged, and connecting the other train to the heat exchanger 6, in order to supply the heat directly to the hydraulic fluid by way of this heat exchanger 6. For this purpose, only one heat exchanger 6 is required, because only part of the exhaust gas stream is used. The additional heat transfer circuit described above is not necessary. To interrupt the heat supply to the hydraulic oil, the exhaust gas train between the branch and the heat exchanger 6, which ends in the heat exchanger, can be closed by means of a flap or a corresponding slide. This solution has the advantage that the counter-pressure that builds up in the exhaust gas system due to the exhaust gas stream does not increase.

In the exemplary embodiment according to FIG. 6, two heat exchangers 6, 6′ are provided in the first line 31, one behind the other. The cooling circuit 71 of the internal combustion engine 7 is passed by way of the heat exchanger 6. In this regard, the heat exchanger 6 is connected with the line from the internal combustion engine 7 to the cooler 72, analogous to the exemplary embodiment according to FIG. 2. Furthermore, the waste heat of the exhaust gas stream of the internal combustion engine 7 is additionally utilized. For this purpose, the heat exchanger 6′ is incorporated into a heat transfer circuit 62, analogous to the exemplary embodiment according to FIG. 6. Here, too, the heat transfer circuit 62 comprises a pump 63, by way of which a heat transfer medium is circulated between this heat exchanger 6′ and a second heat exchanger 64 that is provided. The second heat exchanger 64 is connected with the exhaust gas line 74 of the internal combustion engine 7, so that the exhaust gas stream of the internal combustion engine 7 can flow through it. Alternatively, here, too, the possibility described above exists for utilizing the exhaust gas heat of the exhaust gas system, for example of branching after a catalytic converter that is present, and conducting one train to the exhaust pipe unchanged, and connecting the other train directly to the heat exchanger 6′, in order to conduct the heat directly to the hydraulic fluid by way of this heat exchanger 6, without the involvement of a heat transfer circuit being required.

Although only a few embodiments of the present invention have been shown and described, it is to be understood that many changes and modifications may be made thereunto without departing from the spirit and scope of the invention.

What is claimed is:

1. A hydraulically-driven work device comprising
(a) a hydraulic motor;
(b) a hydraulic circuit comprising a fluid operating the hydraulic motor;
(c) a hydraulic pump supplying the hydraulic circuit;
(d) an internal combustion engine driving the hydraulic pump; and
(e) at least one heat transfer unit for transfer of thermal energy of a fluid stream of the internal combustion engine to the fluid of the hydraulic circuit.

2. The work device according to claim 1, wherein the hydraulic circuit and a cooling circuit of the internal combustion engine are thermally connected by way of the at least one heat transfer unit.

3. The work device according to claim 2, wherein the at least one heat transfer unit is set up for combined transfer of heat and material, wherein the fluid of the hydraulic circuit functions as a coolant, and wherein the heat transfer unit comprises a coupling and uncoupling device that couples and uncouples the hydraulic circuit and the cooling circuit.

4. The work device according to claim 3, wherein the hydraulic circuit and the cooling circuit are connected by way of a hydraulic fluid tank disposed in the hydraulic circuit.

5. The work device according to claim 2, wherein the at least one heat transfer unit comprises a heat exchanger that is disposed ahead of a cooler in the cooling circuit of the internal combustion engine, wherein at least one of the cooling circuit and the hydraulic circuit has a bypass line that circumvents the heat exchanger, wherein a valve is disposed in the bypass line and is controlled as a function of at least one of a hydraulic fluid stream temperature of the hydraulic circuit and a coolant stream temperature of a coolant stream of the cooling circuit.

6. The work device according to claim 2, further comprising a control and regulation module and a temperature sensor in the hydraulic circuit, wherein the at least one heat transfer unit is connected with the hydraulic circuit or the cooling circuit by way of a valve, wherein the valve is controlled by way of the control and regulation module, wherein the temperature sensor disposed in the hydraulic circuit is connected with the control and regulation module.

7. The work device according to claim 1, wherein the hydraulic circuit and an exhaust gas stream of the internal combustion engine are thermally connected by way of the at least one heat transfer unit.

8. The work device according to claim 7, wherein the at least one heat transfer unit comprises at least one heat exchanger.

9. The work device according to claim 7, wherein an exhaust gas line is disposed on the internal combustion engine and provided with a branch that is connected with the at least one heat transfer unit, wherein the exhaust gas line is provided with a throttle system for temporarily closing the exhaust gas line.

10. The work device according to claim 7, wherein the exhaust gas stream is thermally connected with the hydraulic circuit by way of a heat transfer circuit having a heat carrier fluid, wherein the heat transfer circuit is operated by way of the hydraulic pump.

11. The work device according to claim 10, further comprising a control and regulation module for controlling the hydraulic pump and a temperature sensor disposed in the hydraulic circuit and connected with the control and regulation module.

12. The work device according to claim 10, wherein the heat carrier fluid is a synthetic ester, a salt melt or a liquid metal.

13. The work device according to claim 1, wherein the internal combustion engine has a charger, and the charger has a compressed charging air stream thermally connected with the hydraulic circuit by way of the at least one heat transfer unit.

14. The work device according to claim 13, wherein the at least one heat transfer unit is disposed in a charging air line behind the charger.

15. A method for temporary heating of hydraulic fluid of a hydraulic circuit of a work device having a hydraulic drive for civil engineering work comprising:
(a) supplying the hydraulic circuit by way of a hydraulic pump driven by an internal combustion engine having a coolant circuit;
(b) passing the hydraulic fluid through a heat transfer unit for a defined period of time; and
(c) supplying a fluid stream of the internal combustion engine to the heat transfer unit for transfer of thermal energy.

16. The method according to claim 15, wherein the heat transfer unit is connected with the hydraulic circuit by way of a line, and wherein a multi-way valve is disposed in the line.

17. The method according to claim 15, wherein the hydraulic circuit comprises a fluid tank used as a combined material and heat transfer unit, wherein the hydraulic fluid is simultaneously used as a coolant, and wherein the hydraulic circuit is connected with the cooling circuit of the internal combustion engine for a defined period of time.

18. The method according to claim 17, wherein the hydraulic fluid is a synthetic ester.
